(19) United States
(12) Patent Application Publication
(10) Pub. No.: US 2011/0196539 A1
(43) Pub. Date: Aug. 11, 2011

(54) MULTI-SITE CONTROLLER BATCH UPDATE SYSTEM

(75) Inventors: Ajay N. Nair, Bangalore (IN); Sundaramoorthi T., Bangalore (IN); Jerry Marti, West Sale, OH (US); Joe Stough, Cleveland, OH (US); Anthony Pishnery, North Royalton, OH (US)

(73) Assignee: Honeywell International Inc., Morristown, NJ (US)

(21) Appl. No.: 12/703,476

(22) Filed: Feb. 10, 2010

(51) Int. Cl. G05D 23/19; G05B 15/02

(52) U.S. Cl. 700/276; 700/9

(57) ABSTRACT

A system for multi-site batch setpoint and schedule updating. The system may provide an efficient manner to update hundreds or thousands of site controllers with control setpoints and/or schedules having a common new setting with minimal user intervention. A user may easily setup a batch job by selecting multiple deployed control entities or schedules, specifying the desired setpoint adjustment and initiating the batch job execution. The system may perform the job unassisted by connecting each of the selected site controllers selected, locating the target control entity/schedule, and applying a schedule or setpoint update. The system may record a status of each significant action taken to perform the batch job execution so that the user can review the status at a later time.

The present application is related to U.S. patent application Ser. No. 12/260,046, filed Oct. 28, 2008, entitled “A Building Management Configuration System”. U.S. patent application Ser. No. 12/260,046, filed Oct. 28, 2008, entitled “A Building Management Configuration System”, is hereby incorporated by reference. The present application is related to U.S. patent application Ser. No. 12/643,865, filed Dec. 21, 2009, entitled “Approaches for Shifting a Schedule”. U.S. patent application Ser. No. 12/643,865, filed Dec. 21, 2009, entitled “Approaches for Shifting a Schedule”, is hereby incorporated by reference.

### BACKGROUND

The invention pertains to management schemes and particularly to business and/or building management.

### SUMMARY

The invention is a system for multi-site batch setpoint and schedule updating. The system may provide an efficient manner to update hundreds or thousands of site controllers with control setpoints and/or schedules having a common new setting with minimal user intervention. A user may be given an ability to quickly and easily setup a batch job by selecting multiple deployed control entities or schedules, specifying the desired setpoint adjustment and initiating the batch job execution. The system may perform the work by connection to each of the selected site controllers, locating the target control entity/schedule, and applying the schedule or setpoint update. The system may record a status of each significant action taken to perform the batch job execution so that the user can review the status at a later time.

### BRIEF DESCRIPTION OF THE DRAWING

FIG. 1 is a diagram showing a layout of a supervisor, site controllers, field controllers, and their connections;

FIG. 2 is a diagram showing a batch schedule at a cross-connect module (XCM) controller level;

FIG. 3 is a diagram showing a batch schedule at a Novar Opus Supervisor™ level;

FIG. 4 is a diagram showing a batch setpoint at the XCM controller level; and

FIG. 5 is a diagram showing a batch setpoint at a supervisor level.

### DESCRIPTION

The Novar Opus Supervisor™ (supervisor) may provide a basis of the present invention. The Niagara^{AX} Framework™ (framework) is a software platform which may integrate diverse systems and devices regardless of manufacturers, or communication protocols into a unified platform that can be easily managed and controlled in real time over the Internet using a standard web browser. The Opus™ (Opus) supervisor by Novar™ (Novar) is a software platform which is built on the Niagara^{Ax} Framework™ The supervisor may communicate with numerous of site controllers via an intranet or internet. The Opus supervisor may be used in applications where multiple XCM (cross-connect module) data servers or controllers can be networked together. The supervisor may serve real-time graphical information displays to standard web-browser clients and provide server-level functions such as centralized data logging, archiving, alarming, real-time graphical displays, master scheduling, system-wide database management, and integration with Novar Enterprise™ software. Additionally, the supervisor may provide a comprehensive, graphical engineering toolset for application development. Novar's Enterprise™ software family may be used for energy analysis and business-critical requirements such as alarm handling, systems configuration, data collection and performance monitoring.

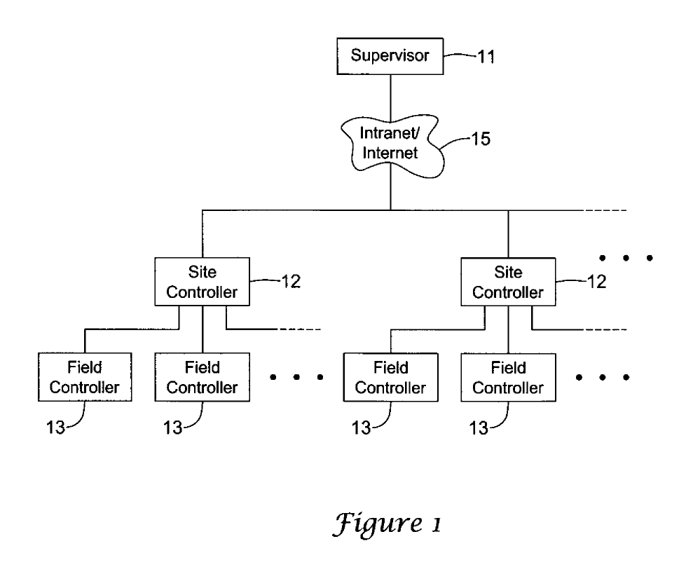

A user of the supervisor may manage and communicate with hundreds or thousands of remote site controllers from a centralized location via a user's intranet. Each of these site controllers may be referred to as an XCM controller (XCM). The XCM in turn may manage and communicate with tens or hundreds of field controllers, within the site, which may be equipment controllers that perform real-time control of building equipment such as, for example, heating, ventilation and air conditioning (HVAC) units, lighting panels and refrigeration circuits. These field or equipment controllers may be referred to as control entities. The XCM may also be configured to directly control building equipment. The building control entities within the site may have operation setpoints that instruct the local control entity how to operate the building equipment. Also, the XCM may provide local schedules so that building control operation decisions can be based on time and date. FIG. 1 is a diagram showing a layout of a supervisor 11, site controllers 12, field controllers 13, connections, and the Intranet/Internet 15.

An issue is that a user of the supervisor may have a need to change the cooling setpoint for a site HVAC control entity in, for instance, one thousand different sites to a common setting. The issue may be communicated in the following scenario. For example, the HVAC controllers may be set to turn on the first stage of cooling at 72 degrees Fahrenheit. The user may decide that, due to seasonal climate changes, it would be better to turn on the first stage of cooling at 74 degrees. To accomplish this task with the supervisor before the present invention, the user would need to manually connect to each site XCM, locate the target HVAC controller entity and alter its cooling setpoint from 72 to 74 degrees. Likewise, the XCM may provide scheduling for the site parking lot lights to turn on at 6:00 PM and to turn off at 10:00 PM when the site facility closes for each of the sites. Due to a holiday, the user of the supervisor may need to change the scheduled off time of this schedule to 11:00 PM in one thousand different sites. To accomplish this task, the user would be required to manually connect to each site XCM, locate the target schedule entity and alter the scheduled off time.

Limitations with a previous system may include the following approach. First, the user may need to manually connect to large numbers of the XCM's to make the setpoint or schedule changes thereby spending an enormous amount of time and effort implementing the changes. Second, as the user connects to each XCM, the user may need to provide login credentials to all of the XCM's requiring prior knowledge of those credentials. Next, the user may need to keep track of the setpoint/schedule updates that are being made to each deployed control entity and the status of any items making the updates.

A goal of the present system is to provide a more efficient manner to update hundreds or thousands of site controllers with control setpoints and/or schedules with a common new setting involving minimal user intervention. The supervisor may provide the user the ability to quickly and easily set up a batch job by selecting multiple deployed control entities or schedules, specifying the desired setpoint adjustment, and initiating the batch job execution. The supervisor may perform the work unassisted by executing the batch job by connecting to each of the site XCM's selected, locating the target control entity/schedule, and applying the setpoint update. The supervisor may record the status of each significant action taken to perform the batch job execution so the user can review it at a later time. Generically, schedules, setpoints and certain controllers may be referred to as “control type entities”.

Aspects of the present system may include: 1) Easy usability—a wizard based setup/list selection; 2) Quick setup—a setup for a change to thousands of sites may involve minimal time; 3) Batch job execution—the job may be run immediately or later on a time schedule; 4) Batch job history—a record of execution events may be maintained; and 5) Batch job retention for later reuse.

As for previous systems, that have a supervisor, and/or the Niagara Workbench™ (workbench) of which the supervisor is based upon, may require the user to manually connect to each deployed XCM, locate the control entity/schedule, and make the desired change. The present system may greatly simplify and increase the efficiency relative to actions required to perform the same functions.

To utilize the present Opus batch setpoint/schedule job feature, a configuration user may need to configure the site controllers with specific property settings to enable the new batch features. Many Novar™ customers may have common site controller configuration footprints, so that present configuration may be done within a few site templates which in turn can be used as a basis for each site configuration. The configuration user or configurator would not necessarily be burdened to make this batch feature configuration to each site controller if it utilized the template method.

When configuring a site XCM for batch setpoint support, the configurator may identify each building control subsystem and attach an Opus control entity property for identifying this controller (i.e., building control subsystem) with a unique application use name. If such controller is operating a roof top HVAC unit that is supplying conditioned air to the sales floor of the site building, the control entity name may be set to “Sales Floor”. Once the control entity property has been applied, the configurator may use a new Opus supervisor slot sheet view to select and identify the control setpoints that are available to the batch job feature for the selected control entity. The Opus slot sheet may provide a menu option called “Add for Batch”. When invoked, the selected setpoints may be added to an Opus batch list under the Opus control entity property. In configuring the site XCM controller for batch schedule support, the configurator may identify each schedule and attach an Opus schedule entity property to the schedule identifying the schedule with a unique schedule name. If the schedule is used for controlling the parking lot lights, the schedule entity name may be set to “Parking Lights”. This may complete the required configuration at the site XCM for supporting the batch job feature.

Once deployed, the XCM controller may execute a background service to maintain a valid list of control entities and schedule entities in the supervisor. The service may monitor any user changes to the Opus control entity and the Opus schedule entity configuration and update to the supervisor as needed. This may be done so that the supervisor can provide the user of the batch job feature, an accurate and quick list of available control entities and schedules to operate upon.

The supervisor application may provide the user with a wizard-based user interface experience, providing easy steps to setup the batch job. For the batch setpoint job, the user may be provided the list of deployed site control entities, organized within easily selectable lists of Enterprise™ groups, sites, and XCM controllers. The user may select one or more control entities to apply a setpoint change to, and next be prompted with a list of setpoints that can be adjusted. The user may make the desired change to one or more setpoints, and next either perform the batch job instantly or at a scheduled time to run later. Herein, the term “instantly” may mean nearly or virtually instantly. Upon execution of the batch job, the supervisor may automatically connect to each selected site, locate the target control entity and apply the setpoint changes. The supervisor may also save the batch jobs for reuse at a later time. A runtime execution history may be maintained for each batch job execution so that the user can review, after the execution to all sites is completed, for any failures during the process. The supervisor may also provide for batch schedule jobs. A similar user experience may be applicable as described for the batch setpoint jobs. The difference may be regarded as the user selects from a list of schedules and applies schedule oriented changes.

The components to provide the new batch job feature may include: 1) an Opus control entity property; 2) an Opus schedule entity property; 3) an Opus slot sheet and/or Opus batch list; 4) an Opus XCM update service; 5) an Opus supervisor batch setpoint/schedule setup wizard; and 6) Opus batch jobs.

The present system may relate to an algorithm that monitors all of the XCM's to check if any new controllers with setpoint/schedule entities are being added. Any new addition or change made to the entities in the XCM may be detected by the algorithm. When a change is detected, all of the new changes may be pushed to the supervisor with all of the controller information. Thus, the algorithm may make sure that the supervisor will be updated at about every controller change. From the supervisory level, the user may be provided with an interface to select the specific XCM/controller which needs to be updated. The selection may be a multi-selection or be based on patterns. If the user has selected more than one controller to be updated, the algorithm may pull up the first controller from the XCM, and so on. If algorithm cannot connect to the first controller, an attempt may be made to connect to the next controller, and so on as necessary, in the XCM. Once connected, the controller details may be shown to the user at the supervisory level. Now the user may make schedule or setpoint changes based on the option that has been selected. Next, the user may be asked to update all of these changes

Instantly, where all of the updates to the XCM are to be done at that time, the batch report may generate the number of successful and failed jobs for the user to keep track of the job progress. The changes to be updated in all of the XCM's at a later point of time may be scheduled at the user's convenience.

Aspects of the present system may include the following items. The service algorithm may be written such that it self-monitors the XCM for new controller changes. Any new changes detected may be triggered and updated to the supervisor. This way the supervisor will not necessarily be clogged with all of the XCM's trying to connect to the supervisor.

There may be a significant reduction of an amount of time needed for the user to keep track of any new controller (schedule/setpoint) changes as all of this operation would be automated.

The present system may provide the user with a rich interface where the user can easily select the group, site, XCM and controller that needs to be updated.

The system may have a provision for the user to select multiple controllers from the list box or by using patterns. This provision may help in easily filtering the controllers.

There may be a provision for the user to update hundreds of XCM's instantly or to schedule an update to run at a later specified time.

There may be a provision for the user to reuse a previously established batch job. The system may provide a status report of the operation performed (success/failure). There may be a remarkable improvement in performance.

The following is an approach for making use of the invention at the XCM and supervisor levels. The following items may apply to the XCM level. A service algorithm may be written to run on each XCM. It may run at frequent intervals of time thereby continuously monitoring the XCM for any addition/changes of schedule or setpoint entities. An addition to or modification of the schedule or setpoint entities may be detected and be pushed to the supervisor, which is to be the repository for all XCM entity information. For schedules, an Opus schedule component may be added to differentiate itself as a schedule entity. The user may have to drag and drop this component into the corresponding schedules that need to be changed. For setpoints, an Opus control entity component may be added to differentiate itself as a setpoint entity. The user may have to drag and drop this component to the corresponding controller that needs to be changed. Then the user may select the respective setpoints from the slot sheet, which are required to be modified. These respective setpoints may be displayed in the supervisor for the user to make the necessary changes. Also for setpoints, user may have to make use of an Opus slot sheet which allows the user to select the specific types of setpoints the user wants to modify. Just these setpoints would be displayed to the user for modifications.

The following items may apply to the supervisor level. The supervisor may act as the central repository for storing references to all the XCM entities (schedules and setpoints). By this way, the supervisor may know the exact navigation path of the XCM at where these entities will be available. The user may be provided with an interface to select the respective group, site, XCM and controller which needs to be modified. The selection may be made from a list box (multi-selection or based on patterns). This may help in easy filtration of controllers. The user may select a list of controllers that need to be modified, say forty controllers. The algorithm may connect to the first XCM controller and fetch the controller's value and display the value to the user. If the algorithm is not able to connect to the first controller, the algorithm may attempt to connect to the next available controller. This process may continue until the algorithm connects to any one of the forty controllers. The user may make the schedule/setpoint changes from a user interface (UI) display. Any changes made or added by the user at the supervisory level may be cloned and stored in the supervisor. This cloned entity may be made available to the user for later use. The user may update all of the forty controllers instantly or later at a specific time. If the user has selected to run the update instantly, all forty controllers may be updated with the newly modified setpoint and schedule values. While updating, matching may be done with the source and target. This is because if you pick multiples, it ensures that the target controller or schedule is of the same type.

A progress pane may be shown to the user which displays the total number of tasks, completed tasks, the number of tasks successfully completed, the number of failures, currently executing tasks, and job details of the operation being done.

The user may also schedule the changes to be updated at a later time. If so, the user may select the appropriate date and time from the user interface. Then all eligible XCM's may be updated only at that scheduled date and time. Once all of the controllers from the respective XCM's are updated, a report may be generated which displays the status (success/failure) of the operation performed. A failed status may also specify the reason for failure so that the user can take corrective action.

The user may also be provided with an interface where the user can reuse the earlier selected XCM/controller values and then make a new modification again. For schedules, the user may have an option to make weekly schedule changes (through out the week) or special event changes (i.e., schedules that need to run on specific days). Special event selection may update just the scheduler's special event schedule but be restricted from changing the weekly schedules.

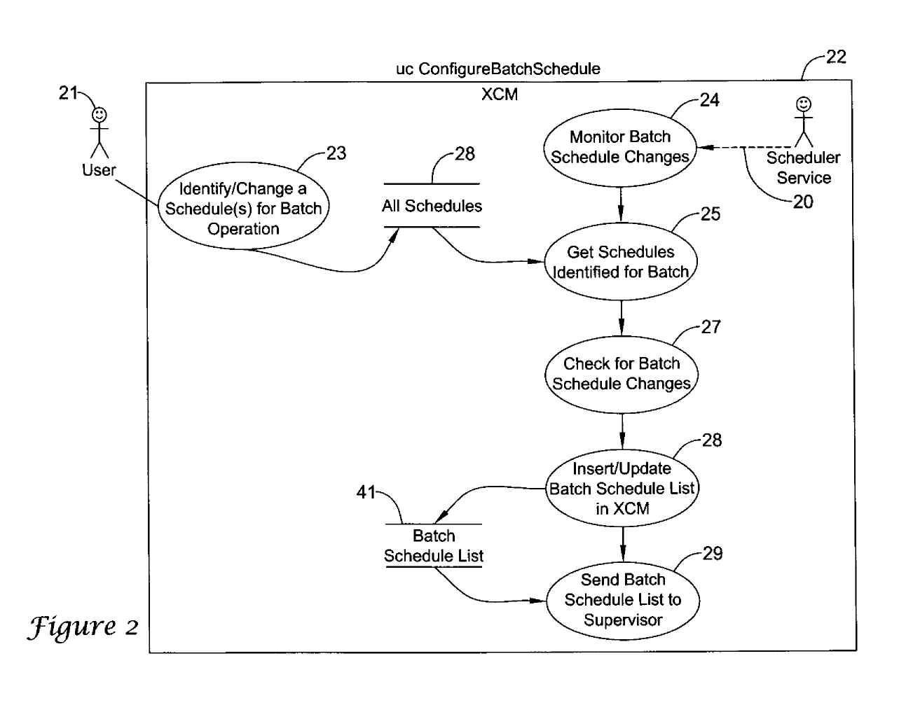

FIG. 2 is a diagram showing a batch schedule at the XCM (JACE controller) level. The actor may be the Opus user, scheduler service. An overview is that the scheduler service may keep monitoring the schedules in the XCM for any new Opus schedule entity. If so, it may update the same in XCM and route it to the supervisor. Pre-conditions may involve that user should have dropped the Opus schedule entity in the schedules. The course of events (steps) may be as in the following. First, the user may drop the Opus schedule entity from the palette in any of the schedules which can include the Boolean schedule, numeric schedule, Enum schedule, string schedule, trigger schedule and the calendar schedule. Second, based on the time frequency mentioned in the service property sheet, the scheduler service may check for any new schedule entity in the schedules. Third, any such new schedule discovered may be updated in the XCM. Fourth, the user may specify the supervisor where the schedules and controller details should be routed to in the property sheet. By default it may be the Opus supervisor. Fifth, the discovered schedules may be routed to the supervisor.

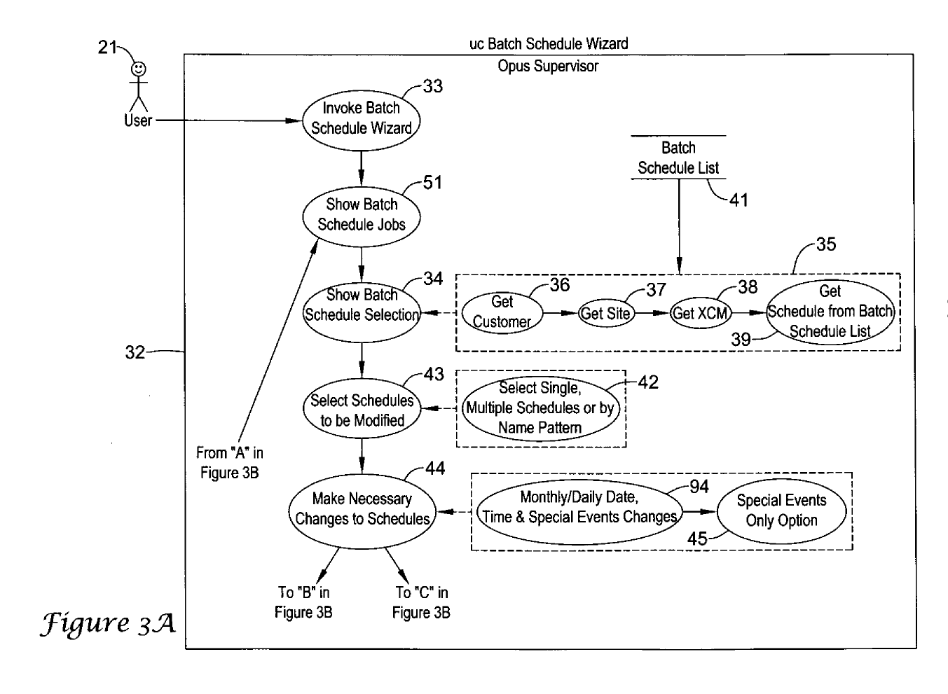

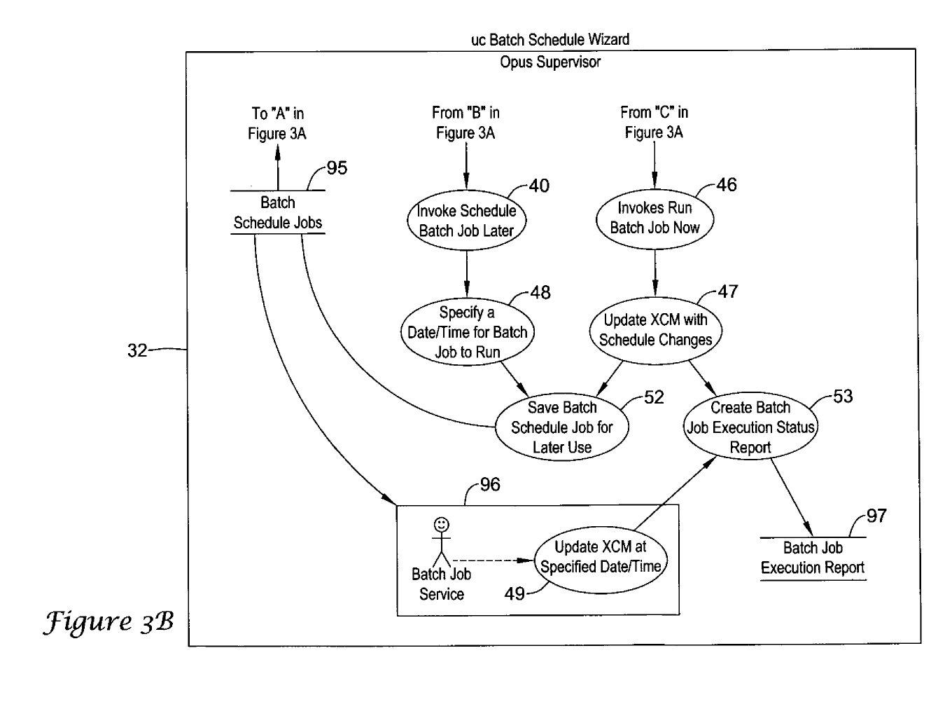

The diagram of FIG. 2 may be further noted in that it relates to configuring a batch schedule relative to an XCM 22. A user 21 may identify and/or change a schedule or schedules for a batch operation as indicated in symbol 23. One may go to all schedules 28. Then at symbol 25, the schedules from all schedules 28 may be identified for a batch. A scheduler service 20 may be utilized to monitor batch schedule changes at symbol 24. Information of the monitoring may go to symbol 25 where the schedules are identified for the batch. The batch may be checked for a schedule change at symbol 27. Information relative to the schedule change may go to symbol 28 where the batch schedule list is inserted and/or updated in the XCM. The insertion/update of the list at symbol 28 may go to the batch schedule list 41 and to symbol 29 where the batch schedule list is sent to an Opus supervisor 32 in FIG. 3.

FIG. 3 is a diagram showing a batch schedule at the supervisor level. The use case name is user scheduling a batch schedule job. The actor may be an Opus user. An overview is that the user may schedule a bulk batch schedule update and then update all the eligible XCM's instantly or at a scheduled time. Pre-conditions may indicate that the supervisor should have all required credentials to the XCM for getting connected. The course of events (steps) may be as in the following. First, the user may invoke the batch schedule from the menu bar. Second, the user may specify the job name and job description. The user may also select the group, site, XCM and schedule details. Schedule selection may be specified as being multi selection or pattern based. Third, if the user has to update only the special events, the user may check the special events check box. By default, it should be a full schedule update. Fourth, the first schedule selected may be pulled up from the XCM and shown to the user to make the user's schedule changes. For any reason, if the first schedule is not available, the system may try to get the 2^{nd} selected schedule and then the 3^{rd} and so on until it gets a valid schedule. Fifth, the user may schedule the user's changes in the respective schedule type displayed to the user. Sixth, the user may have the option to schedule the changes instantly (“Run Now”) or schedule them later (“Schedule Later”). “Run Now” may update all of the XCM's with the new schedule changes instantly. “Schedule Later” may show up as a trigger schedule where the user can specify the date and time to run the schedule changes. All of the XCM's may be updated with these changes at that date and time.

The diagram of FIG. 3 may be further noted in that it relates to a batch schedule wizard for the Opus supervisor 32. A batch schedule list 41 may be received from XCM 22 at symbol 29 in FIG. 2. The batch schedule list 41 may go to symbol 35. User 21 may invoke the batch schedule wizard at symbol 33 and batch schedule jobs may be shown at symbol 51. At symbol 51, a user has a choice to create new batch job by selecting from symbol 35 or to use a previously created batch job from symbol 95. A batch schedule selection may be shown at symbol 34 which may have input from symbol 35. Input from symbol 35 may include get customer at symbol 36, get site at symbol 37, get XCM at symbol 38 and get a schedule at symbol 39 from batch schedule list 41. From symbol 34 where the batch schedule selection is shown, schedules to be modified may be selected at symbol 43 with input from symbol 42 where single or multiple schedules are selected or by name pattern. Necessary changes may be made to schedules at symbol 44 with input from symbol 94 with monthly/daily date, time and special events changes, and symbol 45 with special events only option. After the necessary changes have been made to schedules at symbol 44, the schedule batch job run may be invoked at the present time according to symbol 46, or invoked later according to symbol 40. If invoked later, the date/time for the batch job to run may be specified at symbol 48. Once the date/time is set for triggering the batch job, the batch schedule job may be saved for later use as indicated at symbol 52. Symbol 47 is where the batch job is executed and the changes are sent to the XCM's. If a run of the batch job is invoked at present according to symbol 46, then after the run, the XCM may be updated with schedule changes at symbol 47. The batch schedule job may be saved for later use at symbol 52 and a batch job execution status report may be created at symbol 53. From symbol 52, the batch schedule job may be saved to batch schedule jobs 95. Information about batch schedule jobs 95 may go to symbol 51, which shows batch schedule jobs and to symbol 96 which may provide a batch job service to symbol 49 which updates the XCM at a specified date/time. Symbol 51 is where the user can select and reuse a previously setup batch schedule job. Symbol 96 may encapsulate the batch job service that will execute the batch jobs that were scheduled in symbol 48. Information from symbol 49 may go to the symbol 53 when the batch job execution status report is created. From symbol 53, a batch job execution report 97 may be provided.

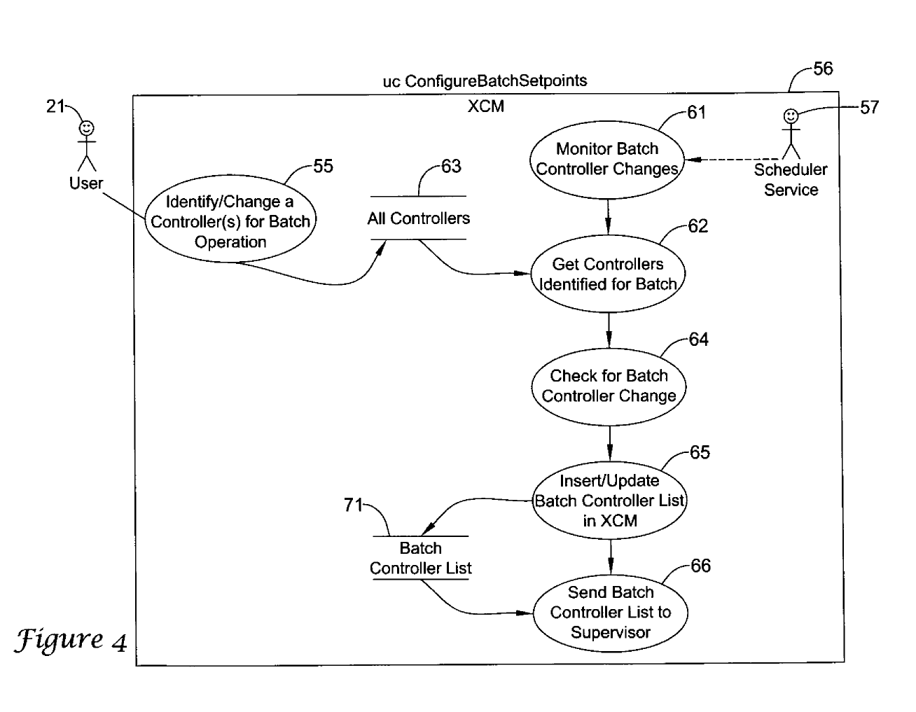

FIG. 4 is a diagram showing a batch setpoint at the XCM level. The use case name is of the updating the supervisor on XCM control entities' changes. The actor may be the Opus user, Opus batch service. An overview is that the Opus batch service may monitor the XCM for Opus control entity updating in the XCM. It may update the supervisor on any change. Pre-conditions may involve that the Opus Batch service should be available and running in the XCM. The course of events (steps) may be as in the following. First, the Opus batch service may be added in the XCM station and started. Second, the user may add the Opus control entity to each controller. Third, the Opus batch service may update the Opus control entity details to the supervisor.

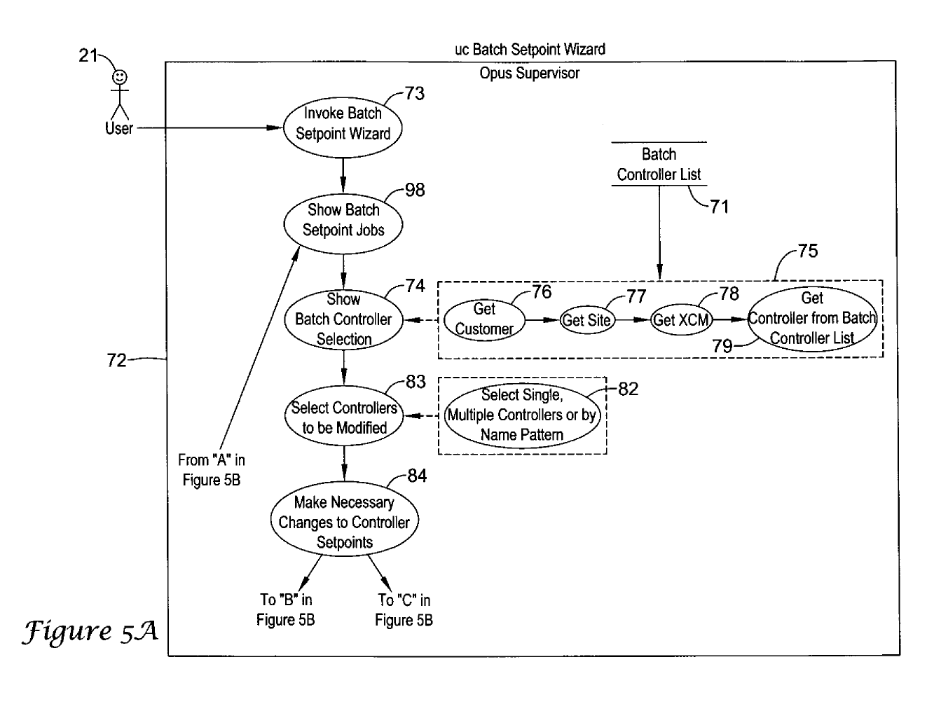

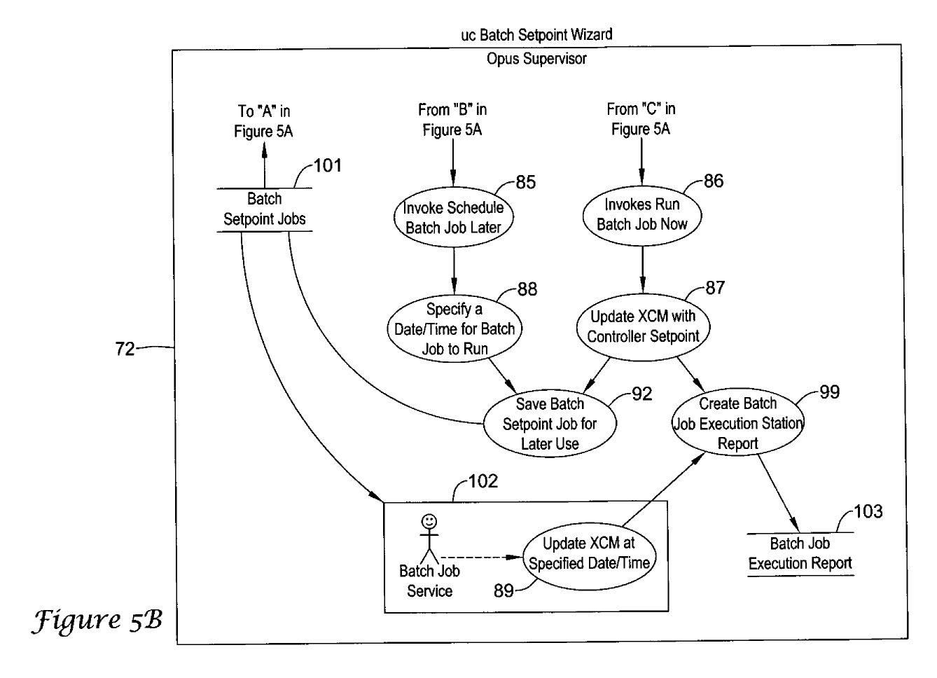

The diagram of FIG. 4 may be further noted in that it relates to configuring batch setpoints relative to an XCM 56. A user 21 may identify/change a controller or controllers for a batch operation as indicated in symbol 55. From symbol 55, one may go to all controllers 63. A scheduler service 57 may provide information to symbol 61 where batch controller changes are monitored. Information from symbol 61 and all controllers 63 may go to symbol 62 where controllers are identified for a batch. Then at symbol 64, a batch controller change may be checked for with information from symbol 62. A batch controller list 71 in XCM may be inserted and/or updated with information from symbol 65. At symbol 66, with information from symbol 65 and the batch controller list 71, a batch controller list may be sent to an Opus supervisor 72 in FIG. 5.

FIG. 5 is a diagram showing a batch setpoint at a supervisor level. The use case name is of the user scheduling batch setpoint job update. The actor may be an Opus user. An overview is that the user may schedule batch setpoint job changes and then update all of the eligible XCM's instantly or at a scheduled time. Pre-conditions may involve that the supervisor should have all required credentials to the XCM for getting connected. The course of events may be as in the following. First, the user may invoke the batch setpoint update option. Second, the user may specify the job name and job description. The user may also select the group, site, XCM and controller details. Controller details may be specified as multi selection or pattern based. Third, the first controller selected may be pulled up from the XCM and the control setpoints configured for that controller may be shown to the user to make his changes. For any reason, if the first controller is not available, it may try to get the 2^{nd} controller and then the 3^{rd} and so on unless it gets a valid controller. Fourth, the user may have the option to schedule the changes instantly (“Run Now”) or schedule it later (“Schedule Later”). “Run Now” may update all the XCM's with the new setpoint changes instantly. “Schedule Later” may show up a trigger schedule where the user can specify the date and time to run the setpoint changes. All XCM's may be updated with these changes at that scheduled time and date.

The diagram of FIG. 5 may be further noted in that it relates to a batch setpoint wizard from the Opus supervisor 72. The batch controller list 71 may be received from XCM 56 at symbol 66 in FIG. 4. At symbol 98, a user has a choice to create a new batch job by selecting from symbol 75 or to use a previously created batch job from symbol 101. The batch controller list 71 may go to symbol 75. User 21 may invoke the batch setpoint wizard at symbol 73 and the batch setpoint jobs may be shown at symbol 98. Symbol 98 is where a user can select and reuse a previously setup batch setpoint job. A batch controller selection may be shown at symbol 74 which can have input from symbol 75. Input from symbol 75 may include get customer at symbol 76, get site at symbol 77, get XCM at symbol 78 and get a controller at symbol 79 from batch controller list 71. From symbol 74, where the batch controller selection is shown, controllers to be modified may be selected at symbol 83 with input from symbol 82 where single or multiple controllers are selected or by name pattern. Necessary changes may be made to controller setpoints at symbol 84. After the necessary changes have been made to controller setpoints at 84, the schedule batch job run may be invoked at present according to symbol 86 or invoked later according to symbol 85. If invoked later, the date/time for the batch job to run may be specified at symbol 88. Once the batch job is run, the batch setpoint job may be saved for later use as indicated at symbol 92. If a run of the batch job is invoked at the present time according to symbol 86, then after the run, the XCM may be updated with the controller setpoint at symbol 87. The batch setpoint job may be saved for later use at symbol 92 and a batch job execution station report may be created at symbol 99. From symbol 92, the batch setpoint job may be added to batch setpoint jobs 101. Information about batch setpoint jobs 101 may go to symbol 98, which shows batch setpoint jobs and to symbol 102 which may provide a batch job service to symbol 89 which updates the XCM at a specified date/time. Information from symbol 89 may go to symbol 99 where the batch job execution station report is created. From symbol 99, a batch job execution report 103 may be provided.

In the present specification, some of the matter may be of a hypothetical or prophetic nature although stated in another manner or tense.

Although the present system has been described with respect to at least one illustrative example, many variations and modifications will become apparent to those skilled in the art upon reading the specification. It is therefore the intention that the appended claims be interpreted as broadly as possible in view of the prior art to include all such variations and modifications.

What is claimed is:

1. A controller updating system for building controls, comprising:
a supervisor; and
a plurality of site controllers; and
wherein:
the supervisor is a platform that communicates with the plurality of site controllers via an intranet or internet; and
the supervisor is set up to provide a batch job by selecting multiple deployed control entities or schedules, specifying a desired schedule or setpoint adjustment or update, and initiating an execution of the batch job.

2. The system of claim 1, wherein execution of the batch job comprises connecting the selected site controllers, locating a target control entity schedule, and applying a schedule or setpoint adjustment or update.

3. The system of claim 2, wherein the site controllers are configured for performing real-time control of building equipment.

4. The system of claim 3, wherein the building equipment comprises heating, ventilation and air conditioning unit, lighting panels and/or refrigeration circuits.

5. The system of claim 2, wherein the site controllers are configured to directly control building equipment.

6. The system of claim 1, wherein each site controller can communicate with a plurality of field controllers.

7. The system of claim 6, wherein each of the plurality of field controllers can perform real-time control of building equipment.

8. The system of claim 7, wherein the building equipment comprises heating, ventilation and air conditioning unit, lighting panels and/or refrigeration circuits.

9. The system of claim 1, wherein:
the supervisor enables a user to set up a batch job; and
the batch job specifies schedules and setpoints.

10. The system of claim 9, wherein the batch job is executed by connecting to selected site controllers of the plurality of site controllers, locating a target control entity of each selected site controller, and applying schedule and setpoint adjustments and updates to target control entities.

11. The system of claim 10, wherein the batch job is executed immediately after the batch job is set up, or is executed on a time schedule.

12. The system of claim 2, further comprising recording a status of each step performed to execute the batch job.

13. A method for updating multi-site controllers, comprising:
identifying one or more schedules having a change for a batch operation in a controller;
getting schedules identified for a batch;
checking for a batch schedule change;
updating a batch schedule list in the controller; and
sending the batch schedule list to a supervisor.

14. The method of claim 13, further comprising:
receiving at the supervisor the batch schedule list from the controller;
invoking a batch schedule wizard;
showing batch schedule jobs;
obtaining a schedule from the batch schedule list;
showing a batch schedule selection;
selecting schedules to be modified;
making needed changes to the schedules;
invoking a run of a batch job; and
updating the controller with schedule changes.

15. The method of claim 14, further comprising deciding whether to invoke the run of the batch job immediately or to delay the run of the batch job until a specified date.

16. The method of claim 15, further comprising creating a batch job execution status report.

17. A method for updating multi-site controllers for buildings, comprising:
identifying one or more schedules for a change for batch operation in a controller;
getting controllers identified for a batch;
checking for a batch controller change;
updating a batch controller list in the controller; and
sending the batch controller list to a supervisor.

18. The method of claim 17, further comprising:
receiving the batch controller list at the supervisor from the controller;
invoking a batch setpoint wizard;
showing batch setpoint jobs;
obtaining a controller from the batch controller list;
showing a batch controller selection;
selecting controllers to be modified;
making needed changes to the controllers; and
invoking a run of a batch job.

19. The method of claim 18, further comprising deciding whether to invoke the run of the batch job immediately or to delay invoking the run of the batch job until a specified date.

20. The method of claim 19, further comprising creating a batch job execution status report.
